(19) United States
(12) Patent Application Publication
(10) Pub. No.: US 2026/0082329 A1
(43) Pub. Date: Mar. 19, 2026

(54) Method for Wake-Up Signaling Management in User Equipment

(71) Applicant: MEDIATEK INC., Hsinchu City (TW)

(72) Inventor: Kai-Tai Yang, Hsinchu City (TW)

(73) Assignee: MEDIATEK INC., Hsinchu City (TW)

(21) Appl. No.: 19/299,366

(22) Filed: Aug. 14, 2025

Related U.S. Application Data
(60) Provisional application No. 63/694,388, filed on Sep. 13, 2024.

(51) Int. Cl. H04W 52/02; H04W 76/28

(52) U.S. Cl. CPC H04W 52/0235; H04W 76/28

(57) ABSTRACT

The method for adaptive WUS management in UE operating in wireless communication networks comprises monitoring data usage patterns over a predetermined period to generate usage scenarios, determining a specific usage scenario based on the monitored patterns, and dynamically enabling or disabling WUS based on the determined scenario. The UE analyzes data activity during CDRX cycles and compares usage patterns against thresholds calculated from network configuration parameters including CDRX long cycle offset and Power Saving offset configurations. For light loading scenarios with sporadic data activity, WUS monitoring of DCI format 2_6 is maintained to achieve power savings. For heavy loading scenarios with continuous data activity, WUS monitoring is disabled and the UE directly monitors PDCCH during CDRX on-duration. The adaptive method manages power consumption across diverse application scenarios and maintains compatibility with 3GPP standards.

### CROSS REFERENCE TO RELATED APPLICATIONS

This application claims the benefit of U.S. Provisional Application No. 63/694,388, filed on Sep. 13, 2024. The content of the application is incorporated herein by reference.

### BACKGROUND

In modern wireless communication systems, particularly 5G New Radio (NR) networks, power consumption management is critical for extending battery life of user equipment (UE). Connected Discontinuous Reception (CDRX) is a power saving mechanism that allows a UE to periodically enter sleep mode while maintaining an active connection with the network. During CDRX operation, the UE alternates between active periods (on-duration) where it monitors the Physical Downlink Control Channel (PDCCH) for potential data transmissions, and inactive periods where it can power down certain components to conserve energy. The 3rd Generation Partnership Project (3GPP) introduced the Wake-Up Signal (WUS) mechanism in Release 16. The WUS feature aims to reduce unnecessary wake-ups during CDRX on-duration periods when there is no data intended for the UE. Specifically, the network transmits a wake-up indication through Downlink Control Information (DCI) format 2_6 to inform the UE whether it should wake up during the upcoming CDRX on-duration to monitor the PDCCH.

However, WUS can cause power consumption penalty in heavy loading scenarios due the UE performing redundant wake-up operations. Instead of waking up once for the CDRX on-duration, the UE must wake up twice: first for WUS monitoring (DCI format 2_6 decoding) and then for the actual CDRX on-duration (PDCCH monitoring). This double wake-up pattern consumes more power than would be consumed by simply monitoring the original CDRX on-duration without WUS. Current 5G networks and user equipment lack the intelligence to adapt WUS operation based on actual usage patterns. The static nature of existing WUS implementations fails to optimize power consumption across diverse application scenarios.

### SUMMARY

An embodiment provides a method for power management performed by a user equipment (UE) operating in a wireless communication network. The method comprises monitoring a data usage pattern of the UE over a predetermined monitoring period to generate a plurality of usage scenarios, determining a usage scenario from the plurality of usage scenarios based on the data usage patterns, and determining to enable or disable wake-up signaling (WUS) based on the usage scenario.

In certain aspects, the method further comprises disabling the WUS based on a change of the usage scenario if the WUS is enabled. In certain aspects, the method further comprises enabling the WUS based on a change of the usage scenario if the WUS is disabled.

In certain aspects, determining the usage scenario comprises comparing the data usage pattern against at least one threshold calculated based on network configuration parameters. In certain aspects, the at least one threshold is generated based on at least one of CDRX long cycle offset configuration parameters, Power Saving (PS) offset configuration parameters, or WUS configuration parameters.

In certain aspects, the plurality of usage scenarios comprise a light loading scenario characterized by sporadic data activity and a heavy loading scenario characterized by continuous or frequent data activity.

In certain aspects, monitoring the data usage pattern comprises monitoring data activity during a plurality of Connected Discontinuous Reception (CDRX) cycles. In certain aspects, determining the usage scenario comprises analyzing presence or absence of data transmissions during CDRX on-duration periods across the plurality of CDRX cycles.

In certain aspects, determining to enable WUS comprises configuring the UE to monitor Downlink Control Information (DCI) format 2_6. In certain aspects, determining to disable the WUS comprises configuring the UE to bypass monitoring the DCI format 2_6 and to monitor Physical Downlink Control Channel (PDCCH) during CDRX on-duration.

In certain aspects, monitoring the data usage pattern comprises monitoring at least one of enhanced Mobile Broadband (eMBB) traffic, Ultra-Reliable Low Latency Communication (URLLC) traffic, or massive Machine Type Communication (mMTC) traffic.

An embodiment also provides a user equipment comprising a memory and processor configured to perform the above method steps. In certain aspects, the processor implements the same functionality as described in the method claims, including dynamic WUS switching, threshold-based scenario determination, traffic pattern analysis, and adaptive DCI format 2_6 or PDCCH monitoring based on the identified usage scenario.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exemplary wireless communications system and access network according to an embodiment.

FIG. 2 illustrates block diagrams of a base station in communication with a UE in a wireless network according to an embodiment.

FIG. 3A illustrates an exemplary logical architecture of a distributed RAN according to an embodiment.

FIG. 3B illustrates an exemplary physical architecture of a distributed RAN according to an embodiment.

FIG. 4A illustrates an exemplary DL-centric slot according to an embodiment.

FIG. 4B illustrates an exemplary UL-centric slot according to an embodiment.

FIG. 5 illustrates a timing sequence for a UE operating in a no data or light loading scenario with Wake-Up Signal enabled according to an embodiment.

FIG. 6 illustrates a timing sequence for a UE operating in a heavy loading scenario with Wake-Up Signal disabled according to an embodiment.

FIG. 7 illustrates a flowchart of a method for adaptive Wake-Up Signal management according to an embodiment.

### DETAILED DESCRIPTION

The present invention relates to methods and apparatus for temporal beam prediction and reporting in wireless communication systems, particularly in the context of 3rd Generation Partnership Project (3GPP) based mobile communication systems including Fifth Generation New Radio (5G NR) and beyond. While the embodiments described herein primarily focus on 3GPP wireless networks, the disclosed techniques may be applied to various wireless multiple access systems. Such systems can include Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and Multi-Carrier Frequency Division Multiple Access (MC-FDMA) systems.

In modern wireless networks, a Radio Access Network (RAN) can provide communication services through its connection to a Core Network (CN). The RAN may implement various radio access technologies (RATs), including Evolved Universal Terrestrial Radio Access Network (E-UTRAN) for Long Term Evolution (LTE), Next Generation Radio Access Network (NG-RAN) for 5G NR, or multi-RAT deployments. Within the RAN, access nodes may be referred to by various terms depending on the specific network deployment, including NodeBs, evolved NodeBs (eNBs), next Generation NodeBs (gNBs), RAN nodes, or Transmission Reception Points (TRPs).

The 3GPP introduced the Wake-Up Signal (WUS) in Release 16. The WUS feature operates within the RAN architecture to reduce unnecessary wake-ups during Connected Discontinuous Reception (CDRX) on-duration periods when there is no data intended for the UE. The RAN, comprising base stations (gNBs) and their associated radio resources, coordinates WUS operations through intelligent scheduling and signaling protocols integrated with Physical Downlink Control Channel (PDCCH) management and CDRX timing. Specifically, the gNB within the RAN generates and transmits a wake-up indication through Downlink Control Information (DCI) format 2_6 to inform the UE whether it should wake up during the upcoming CDRX on-duration to monitor the PDCCH. When WUS is enabled, the UE must wake up before each CDRX on-duration period to decode the DCI format 2_6 and determine whether to remain awake for PDCCH monitoring. If the wake-up indication signals that no data is pending, the UE can continue sleeping through the entire CDRX on-duration, thereby saving power that would otherwise be consumed during PDCCH monitoring.

While WUS provides power savings in scenarios with infrequent data activity, the current implementation suffers from a significant limitation: it operates in a static manner regardless of the UE's actual usage patterns. This one-size-fits-all approach creates inefficiencies in certain scenarios.

For light loading scenarios, such as messaging, social media interaction, or background music streaming, data transmissions are sporadic with long idle periods between activities. In these scenarios, WUS effectively reduces power consumption by allowing the UE to skip unnecessary PDCCH monitoring periods.

Conversely, for heavy loading scenarios involving continuous data flow such as Voice over New Radio (VoNR), real-time gaming, or live video streaming, the UE frequently receives data during CDRX on-duration periods. In these scenarios, the additional wake-up period required for DCI format 2_6 monitoring becomes a power consumption penalty rather than a benefit. The UE must wake up for WUS monitoring before nearly every CDRX on-duration, only to determine that it must stay awake for PDCCH monitoring anyway.

The static nature of current WUS implementations creates significant power consumption inefficiencies, particularly in heavy loading scenarios where the UE performs redundant wake-up operations-waking up first for WUS monitoring (DCI format 2_6 decoding) and then again for CDRX on-duration (PDCCH monitoring)—consuming more power than simply monitoring the original CDRX on-duration without WUS. This double wake-up pattern is especially problematic in Voice over New Radio scenarios with regular, predictable data patterns that make WUS monitoring largely redundant, contradicting the original power-saving intent. Current 5G networks and user equipment lack the intelligence to adapt WUS operation based on actual usage patterns, failing to optimize power consumption across diverse application scenarios. As 5G networks continue evolving from Internet of Things (IOT) devices with minimal data requirements to high-bandwidth applications requiring constant connectivity, the increasing diversity of usage patterns amplifies the need for dynamic, scenario-aware power management mechanisms that can intelligently enable or disable WUS based on the UE data usage characteristics across the entire spectrum of 5G applications.

The following disclosure addresses the above-mentioned issues by providing an intelligent, adaptive approach to WUS management that optimizes power consumption based on real-time analysis of user equipment data usage patterns.

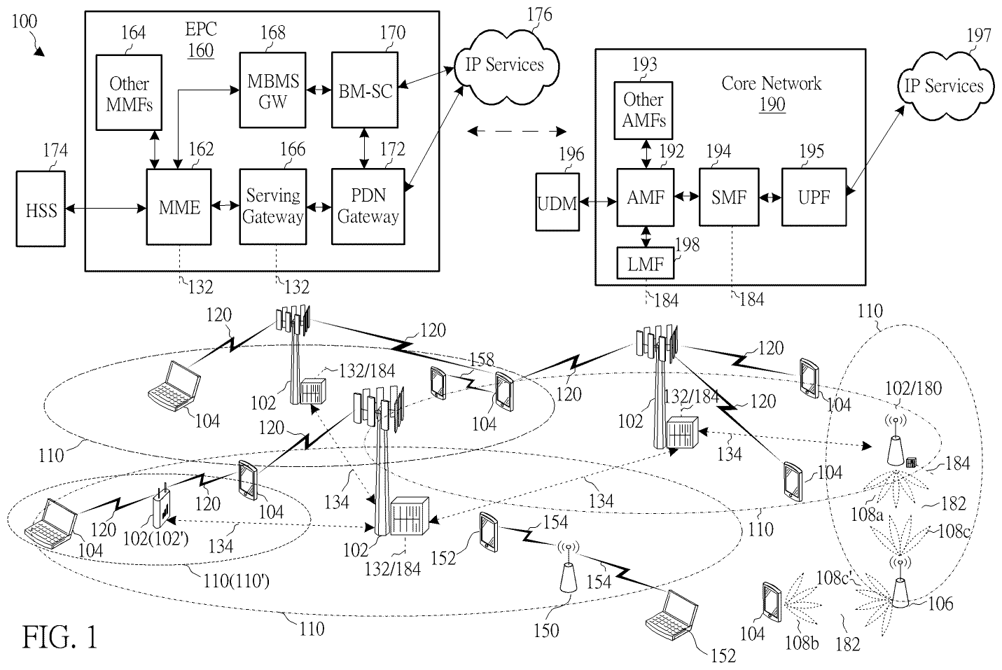

FIG. 1 illustrates an exemplary wireless communications system and access network 100. The wireless communication system (also referred to as a wireless wide area network (WWAN)) includes base stations 102, UEs 104, an Evolved Packet Core (EPC) 160, and an additional core network 190 (such as a 5G Core (5GC)). The base stations 102 can be macrocells (high-power cellular base stations) or small cells (low-power cellular base stations). Macrocells refer to large-scale base stations, while small cells include femtocells, picocells, and microcells.

The base stations 102 designed for 4G LTE operation (collectively known as Evolved Universal Mobile Telecommunications System (UMTS) Terrestrial Radio Access Network (E-UTRAN)) may connect to the EPC 160 via backhaul links 132 (e.g., S1 interface). Similarly, base stations 102 configured for 5G NR (collectively designated as Next Generation RAN (NG-RAN)) can interface with core network 190 through backhaul links 184. These base stations can perform numerous functions beyond basic connectivity, which may include: user data transfer, radio channel encryption and decryption, integrity protection, header compression, mobility management (e.g., handover, dual connectivity), interference coordination between cells, connection management, load distribution, handling of non-access stratum (NAS) messages, NAS node selection, network synchronization, RAN resource sharing, multimedia broadcast services (MBMS), subscriber tracking, RAN information management (RIM), paging services, position determination, and emergency alert distribution. Additionally, base stations 102 may communicate with each other either directly or indirectly (e.g., through the EPC 160 or core network 190) using backhaul links 134 (e.g., X2 interface), which can be implemented as either wired or wireless connections.

The base stations 102 may wirelessly communicate with the UEs 104. Each base station 102 can provide coverage for a specific geographic area 110, and there may be overlapping coverage areas 110. For instance, the small cell 102′ may have a coverage area 110′ that overlaps with the coverage area 110 of one or more macro base stations 102. A network that includes both small cells and macrocells may be referred to as a heterogeneous network. This type of network may also include Home Evolved Node Bs (HeNBs), which can serve a restricted group known as a closed subscriber group (CSG). The communication links 120 between the base stations 102 and the UEs 104 may involve uplink (UL) (also known as reverse link) transmissions from a UE 104 to a base station 102 and/or downlink (DL) (also known as forward link) transmissions from a base station 102 to a UE 104.

The communication links 120 may use multiple-input and multiple-output (MIMO) antenna technology, including spatial multiplexing, beamforming, and/or transmit diversity. The communication links may be through one or more carriers. For each carrier, the base stations 102 and/or UEs 104 may utilize spectrum with bandwidths of various sizes (e.g., 5, 10, 15, 20, 100, 400, etc. MHz) up to 7 MHz per carrier. Through carrier aggregation, these individual carriers can be combined to achieve a total bandwidth of YXX MHz, where X represents the number of component carriers, enabling higher data rates for transmission in each direction. The carriers may or may not be adjacent to one another. The allocation of carriers can be asymmetric with respect to DL and UL, meaning that more or fewer carriers may be allocated for DL than for UL. The component carriers may include a primary component carrier and one or more secondary component carriers. A primary component carrier may be referred to as a primary cell (PCell), while a secondary component carrier can be referred to as a secondary cell (SCell).

Certain UEs 104 may communicate with each other using a device-to-device (D2D) communication link 158. This D2D communication link 158 can utilize the DL/UL WWAN spectrum and may operate on one or more sidelink channels, such as the physical sidelink broadcast channel (PSBCH), physical sidelink discovery channel (PSDCH), physical sidelink shared channel (PSSCH), and physical sidelink control channel (PSCCH). D2D communication can occur through various wireless D2D communication systems, including, for example, FlashLinQ, WiMedia, Bluetooth, ZigBee, Wi-Fi based on the IEEE 802.11 standard, LTE, or NR.

The wireless communications system may also include a Wi-Fi access point (AP) 150, which communicates with Wi-Fi stations (STAs) 152 via communication links 154 in the 5 GHz unlicensed frequency spectrum. When operating in an unlicensed frequency spectrum, the STAs 152 and AP 150 may perform a clear channel assessment (CCA) before communicating to check if the channel is available.

The small cell 102′ may operate in either licensed or unlicensed frequency spectrums, or both. When using an unlicensed frequency spectrum, the small cell 102′ can employ NR and utilize the same 5 GHz unlicensed frequency spectrum as the Wi-Fi AP 150. By employing NR in an unlicensed frequency spectrum, the small cell 102′ may enhance coverage and/or increase capacity of the access network.

A base station 102, which may be a small cell 102′ or a large cell (e.g., macro base station), can include an eNB, gNodeB (gNB), or another type of base station. Some base stations, such as gNB 180, may operate in a traditional sub 6 GHz spectrum, in millimeter wave (mmWave) frequencies, and/or near mmWave frequencies when communicating with the UE 104. When the gNB 180 operates in mmWave or near mmWave frequencies, it can be referred to as an mmWave base station.

Extremely high frequency (EHF) is part of the RF in the electromagnetic spectrum. EHF has a range of 30 GHz to 300 GHz and a wavelength between 1 millimeter and 10 millimeters. Radio waves in this band may be referred to as millimeter waves. Near mmWave may extend down to a frequency of 3 GHz with a wavelength of 100 millimeters. The super high frequency (SHF) band extends between 3 GHz and 30 GHz, also referred to as centimeter wave.

Communications using the mmWave and/or near mmWave radio frequency band (e.g., 3 GHZ-300 GHz) can experience extremely high path loss and have a short range. The mmWave base station 180 may utilize beamforming 182 with the UE 104 to compensate for these limitations.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions 108c. The base station 180 may receive the beamformed signal from the UE 104 in one or more receive directions 108c′. This bidirectional beamforming capability is essential for establishing reliable mmWave communications. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 can communicate with a Home Subscriber Server (HSS) 174. The MME 162 is the control node that processes signaling between the UEs 104 and the EPC 160. Generally, the MME 162 provides bearer and connection management.

All user Internet protocol (IP) packets may transfer through the Serving Gateway 166, which itself connects to the PDN Gateway 172. The PDN Gateway 172 can provide UE IP address allocation as well as other functions. The PDN Gateway 172 and the BM-SC 170 may connect to the IP Services 176. The IP Services 176 can include the Internet, an intranet, an IP Multimedia Subsystem (IMS), a PS Streaming Service, and/or other IP services.

The BM-SC 170 may provide functions for MBMS user service provisioning and delivery. The BM-SC 170 can serve as an entry point for content provider MBMS transmission, may be used to authorize and initiate MBMS Bearer Services within a public land mobile network (PLMN), and can be used to schedule MBMS transmissions. The MBMS Gateway 168 may distribute MBMS traffic to the base stations 102 belonging to a Multicast Broadcast Single Frequency Network (MBSFN) area broadcasting a particular service, and can be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 can communicate with a Unified Data Management (UDM) 196. The AMF 192 is the control node that processes signaling between the UEs 104 and the core network 190. Generally, the SMF 194 may provide QoS flow and session management. The UPF 195 can serve as the pathway for all user IP packets. In addition to providing UE IP address allocation, the UPF 195 may perform various other functions. Connectivity between the UPF 195 and IP Services 197 is possible. The IP Services 197 may include the Internet, an intranet, an IP Multimedia Subsystem (IMS), a PS Streaming Service, and potentially additional IP services.

The base station may also be known as a gNB, Node B, eNB, an access point, a base transceiver station, a radio base station, a radio transceiver, a transceiver function, a basic service set (BSS), an extended service set (ESS), a transmit reception point (TRP), or other suitable terminology. The base station 102 can function as an access point to the EPC 160 or core network 190 for a UE 104.

Although this document discusses 5G NR technology, the concepts presented are also relevant to various other wireless communication standards and technologies. These include 4G LTE, LTE-A, CDMA, GSM, and may extend to future generations of wireless and radio access technologies that will evolve from current standards.

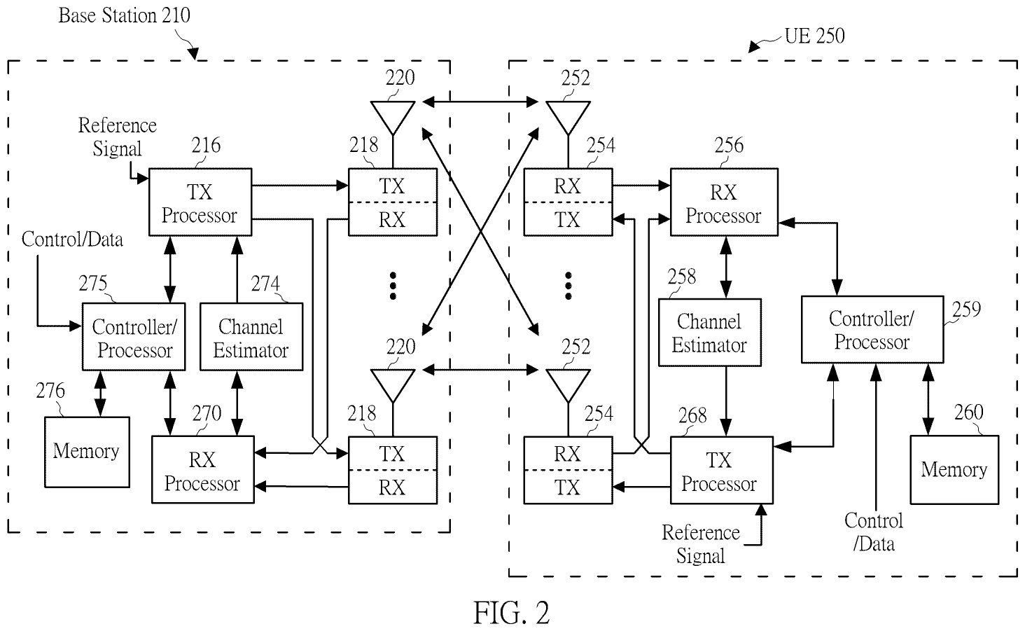

FIG. 2 illustrates block diagrams of a base station 210 in communication with a UE 250 in a wireless network. In the DL, IP packets from the EPC 160 may be provided to a controller/processor 275. The controller/processor 275 can implement layer 3 and layer 2 functionality. Layer 3 includes a radio resource control (RRC) layer, and layer 2 may include a packet data convergence protocol (PDCP) layer, a radio link control (RLC) layer, and a medium access control (MAC) layer.

The controller/processor 275 can manage RRC layer functions related to broadcasting system information (e.g., MIB, SIBs), RRC connection control (e.g., RRC connection paging, establishment, modification, and release), radio access technology (RAT) mobility, and the configuration of measurements for UE measurement reporting. The controller/processor 275 may also handle PDCP layer functions related to header compression/decompression, security (including ciphering, deciphering, integrity protection, and integrity verification), and handover support; RLC layer functions for transferring upper layer packet data units (PDUs), error correction through ARQ, concatenation, segmentation, and reassembly of RLC service data units (SDUs), re-segmentation of RLC data PDUs, and reordering of RLC data PDUs; and MAC layer functions that include mapping logical channels to transport channels, multiplexing MAC SDUs onto transport blocks (TBs), demultiplexing MAC SDUs from TBs, reporting scheduling information, error correction through HARQ, priority handling, and logical channel prioritization.

The transmit (TX) processor 216 and the receive (RX) processor 270 may perform layer 1 functions related to various signal processing tasks. Layer 1, which includes the physical (PHY) layer, involves error detection on transport channels, forward error correction (FEC) coding/decoding of transport channels, interleaving, rate matching, mapping onto physical channels, modulation/demodulation of physical channels, and MIMO antenna processing.

The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then divided into parallel streams. Each stream is mapped to an OFDM subcarrier, multiplexed with a reference signal (e.g., pilot) in the time and/or frequency domain, and then combined using an Inverse Fast Fourier Transform (IFFT) to produce a physical channel carrying a time-domain OFDM symbol stream.

The OFDM stream can be spatially precoded to generate multiple spatial streams. Channel estimates from a channel estimator 274 help determine the coding and modulation scheme, as well as assist in spatial processing. These estimates are derived from a reference signal and/or feedback on channel conditions transmitted by the UE 250. Each spatial stream is sent to a different antenna 220 via a separate transceiver 218. Each transceiver 218 modulates an RF carrier with its respective spatial stream for transmission.

At the UE 250, each transceiver 254 receives a signal through its respective antenna 252. The transceiver 254 recovers the information modulated onto the RF carrier and passes it to the RX processor 256. The TX processor 268 and RX processor 256 handle layer 1 functionality associated with various signal processing tasks. The RX processor 256 performs spatial processing on the received information to recover any spatial streams intended for the UE 250. If multiple spatial streams are directed to the UE 250, the RX processor 256 combines them into a single OFDM symbol stream. The RX processor 256 then converts the time-domain OFDM symbol stream into the frequency domain using a Fast Fourier Transform (FFT). The frequency-domain signal consists of a separate OFDM symbol stream for each subcarrier of the OFDM signal.

The symbols on each subcarrier, and the reference signal, can be recovered and demodulated by determining the most likely signal constellation points transmitted by the base station 210. These soft decisions may be based on channel estimates computed by the channel estimator 258. The soft decisions can then be decoded and deinterleaved to recover the data and control signals that were originally transmitted by the base station 210 on the physical channel. The data and control signals may then be provided to the controller/processor 259, which implements layer 3 and layer 2 functionality.

The controller/processor 259 may be linked to a memory 260 that holds program code and data, with the memory 260 often referred to as a computer-readable medium. In the UL, the controller/processor 259 handles tasks such as demultiplexing between transport and logical channels, packet reassembly, deciphering, header decompression, and control signal processing to recover IP packets from the EPC 160. Additionally, the controller/processor 259 is responsible for error detection through an ACK and/or NACK protocol to support HARQ operations.

Similar to the DL transmission functionality provided by the base station 210, the controller/processor 259 handles RRC layer functions related to system information (e.g., MIB, SIBs) acquisition, RRC connections, and measurement reporting; PDCP layer functions for header compression/decompression and security (including ciphering, deciphering, integrity protection, and integrity verification); RLC layer functions for transferring upper layer PDUs, error correction through ARQ, concatenation, segmentation, and reassembly of RLC SDUs, re-segmentation of RLC data PDUs, and reordering of RLC data PDUs; and MAC layer functions that include mapping logical channels to transport channels, multiplexing MAC SDUs onto TBs, demultiplexing MAC SDUs from TBs, scheduling information reporting, error correction through HARQ, priority handling, and logical channel prioritization.

Channel estimates derived by a channel estimator 258 from a reference signal or feedback transmitted by the base station 210 may assist the TX processor 268 in selecting the appropriate coding and modulation schemes, and in facilitating spatial processing. The spatial streams generated by the TX processor 268 can be transmitted to different antennas 252 via separate transceiver 254, with each transceiver modulating an RF carrier with its respective spatial stream. The UL transmission is processed at the base station 210 in a similar manner to the receiver function at the UE 250, where each transceiver 218 receives a signal through its respective antenna 220, recovers the modulated information, and sends it to a RX processor 270.

The controller/processor 275 may be linked to a memory 276 that stores program codes and data, with the memory 276 typically referred to as a computer-readable medium. In the UL, the controller/processor 275 manages demultiplexing between transport and logical channels, packet reassembly, deciphering, header decompression, and control signal processing to recover IP packets from the UE 250. These IP packets are then forwarded to the EPC 160. The controller/processor 275 is also responsible for error detection using an ACK and/or NACK protocol to support HARQ operations.

New Radio (NR) may refer to radios designed to operate on a new air interface (different from OFDMA-based interfaces) or a fixed transport layer (other than IP). NR may use OFDM with a cyclic prefix (CP) on both the UL and DL, and supports half-duplex operation using time division duplexing (TDD). NR may include services like Enhanced Mobile Broadband (eMBB) targeting wide bandwidth (e.g., 80 MHz or more), mmWave for high carrier frequencies (e.g., 60 GHZ), massive Machine-Type Communications (mMTC) for non-backward compatible MTC techniques, and/or communications targeting ultra-reliable low latency communications (URLLC).

A single component carrier bandwidth of 100 MHz may be supported. In one example, NR resource blocks (RBs) can span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot can indicate a link direction (i.e., DL or UL) for data transmission and the link direction for each slot may be dynamically switched. Each slot can include DL/UL data as well as DL/UL control data. UL and DL slots for NR may be described in more detail below.

The NR RAN may include a central unit (CU) and distributed units (DUs). A NR BS (e.g., gNB, 5G Node B, Node B, transmission reception point (TRP), access point (AP)) can correspond to one or multiple BSs. NR cells may be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells can operate without transmitting synchronization signals (SS), while in other cases they may transmit SS. NR BSs may transmit downlink signals to UEs indicating the cell type. Based on the cell type indication, the UE can communicate with the NR BS. For example, the UE may determine which NR BSs to consider for cell selection, access, handover, and/or measurement based on the indicated cell type.

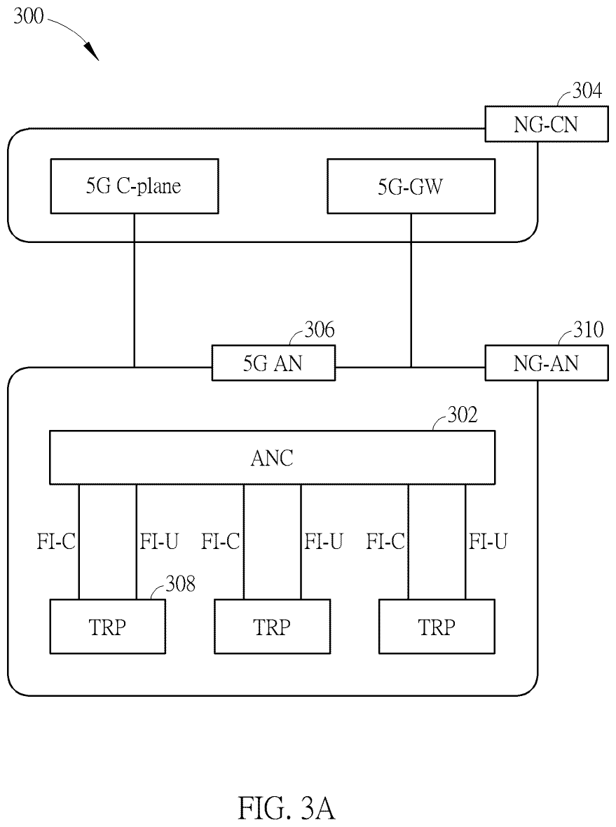

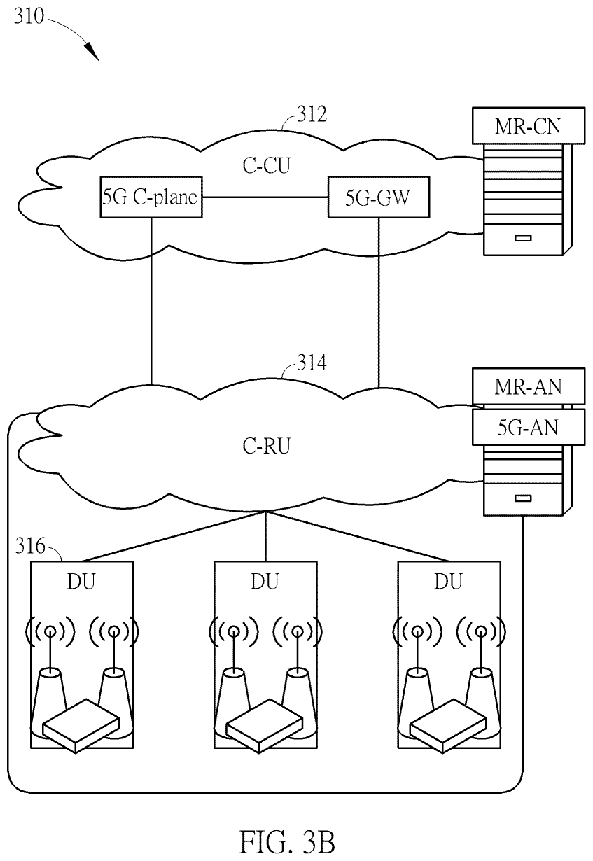

FIG. 3A illustrates an exemplary logical architecture of a distributed RAN 300. A 5G access node 306 may include an access node controller (ANC) 302. The ANC can be a central unit (CU) of the distributed RAN. The backhaul interface to the next generation core network (NG-CN) 304 may terminate at the ANC. The backhaul interface to neighboring next generation access nodes (NG-ANs) 310 can also terminate at the ANC. The ANC may include one or more TRPs 308 (which may also be referred to as BSs, NR BSs, Node Bs, 5G NBs, APs, or some other term). As described above, a TRP can be used interchangeably with “cell.”

The TRPs 308 may function as a distributed unit (DU). The TRPs can connect to one ANC (ANC 302) or more than one ANC (not illustrated). For example, for RAN sharing, radio as a service (RaaS), and service specific ANC deployments, the TRP may connect to more than one ANC. A TRP can include one or more antenna ports. The TRPs may be configured to individually (e.g., dynamic selection) or jointly (e.g., joint transmission) serve traffic to a UE.

The local architecture of the distributed RAN 300 can be used to illustrate fronthaul definition. The architecture may be defined to support fronthauling solutions across different deployment types. For example, the architecture can be based on transmit network capabilities (e.g., bandwidth, latency, and/or jitter). The architecture may share features and/or components with LTE. According to aspects, the next generation AN (NG-AN) 310 can support dual connectivity with NR. The NG-AN may share a common fronthaul for LTE and NR. The architecture can enable cooperation between and among TRPs 308. For example, cooperation may be preset within a TRP and/or across TRPs via the ANC 302.

In certain implementations, no inter-TRP interface may be needed or present. In certain implementations, a dynamic configuration of split logical functions can be present within the architecture of the distributed RAN 300. The PDCP, RLC, MAC protocol may be adaptably placed at the ANC or TRP.

FIG. 3B illustrates an exemplary physical architecture of a distributed RAN 310. A centralized core network unit (C-CU) 312 may host core network functions. The C-CU can be centrally deployed. C-CU functionality may be offloaded (e.g., to advanced wireless services (AWS)), in an effort to handle peak capacity. A centralized RAN unit (C-RU) 314 may host one or more ANC functions. Optionally, the C-RU can host core network functions locally. The C-RU may have distributed deployment. The C-RU can be positioned closer to the network edge. A distributed unit (DU) 316 may host one or more TRPs. The DU can be located at edges of the network with radio frequency (RF) functionality.

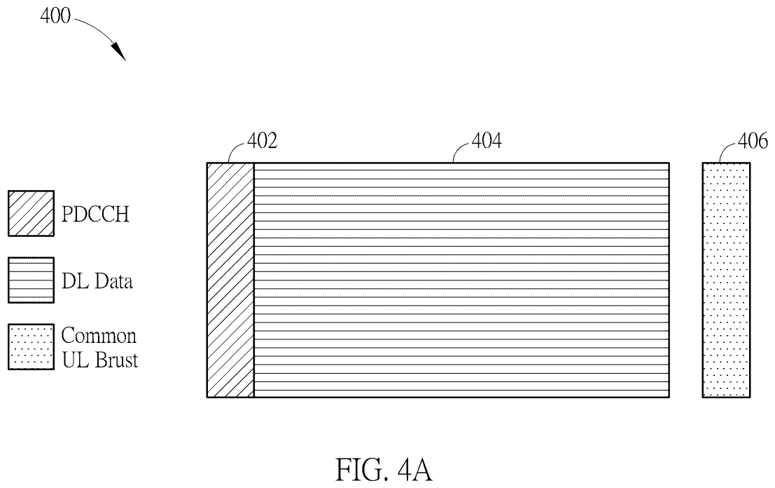

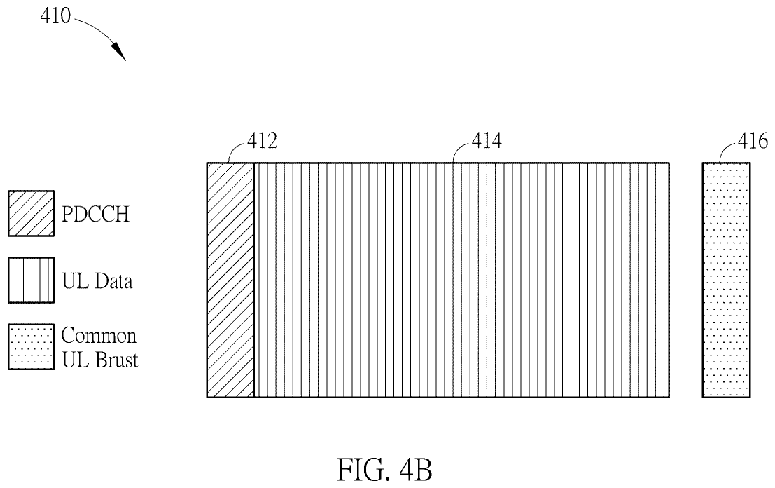

FIG. 4A illustrates an exemplary DL-centric slot 400. This DL-centric slot 400 may include a control portion 402, which typically appears in the initial or beginning part of the slot. The control portion 402 can contain various scheduling and/or control information corresponding to different sections of the DL-centric slot. In certain configurations, the control portion 402 may be implemented as a physical DL control channel (PDCCH).

The DL-centric slot 400 also includes a DL data portion 404, which is often referred to as the payload of the DL-centric slot. This DL data portion 404 encompasses the communication resources used to transmit DL data from the scheduling entity (e.g., UE or BS) to the subordinate entity (e.g., UE). In some cases, the DL data portion 404 may be a physical DL shared channel (PDSCH).

Additionally, the DL-centric slot 400 may include a common UL portion 406. This portion can be called an UL burst, a common UL burst, or other suitable terms. The common UL portion 406 may carry feedback information related to other sections of the DL-centric slot. For instance, the common UL portion 406 can provide feedback on the control portion 402. Examples of such feedback information include an ACK signal, a NACK signal, a HARQ indicator, or other relevant data. The common UL portion 406 can also carry additional or alternative information, such as data related to random access channel (RACH) procedures, scheduling requests (SRs), or other suitable types of information.

As shown in FIG. 4A, the end of the DL data portion 404 may be separated in time from the beginning of the common UL portion 406. This time separation is commonly referred to as a gap, guard period, guard interval, or other suitable terms. This separation allows sufficient time for the switch-over from DL communication (e.g., reception by the subordinate entity, such as the UE) to UL communication (e.g., transmission by the subordinate entity, such as the UE).

FIG. 4B illustrates an exemplary UL-centric slot 410. The UL-centric slot 410 may include a control portion 412, which may appear in the initial or beginning part of the UL-centric slot. The control portion 412 in FIG. 4B may be similar to the control portion 402 described above with reference to FIG. 4A. The UL-centric slot 410 may also include an UL data portion 414, which is sometimes referred to as the payload of the UL-centric slot. The UL data portion 414 represents the communication resources used to transmit UL data from the subordinate entity (e.g., UE) to the scheduling entity (e.g., UE or BS). In some configurations, the control portion 412 may be a physical DL control channel (PDCCH).

As illustrated in FIG. 4B, the end of the control portion 412 may be separated in time from the beginning of the UL data portion 414. This time separation is commonly referred to as a gap, guard period, guard interval, or other suitable terms. This separation allows time for the switch-over from DL communication (e.g., reception by the scheduling entity) to UL communication (e.g., transmission by the scheduling entity).

The UL-centric slot 410 may also include a common UL portion 416, which in FIG. 4B may be similar to the common UL portion 506 described above with reference to FIG. 4A. The common UL portion 416 can also carry additional or alternative information, such as channel quality indicator (CQI) feedback, sounding reference signals (SRSs), or other suitable types of information.

In some cases, two or more subordinate entities (e.g., UEs) may communicate with each other using sidelink signals. Real-world applications of sidelink communications can include public safety, proximity services, UE-to-network relaying, vehicle-to-vehicle (V2V) communications, Internet of Everything (IoE) communications, IoT communications, mission-critical mesh, and other suitable applications. Generally, a sidelink signal refers to a communication sent directly between subordinate entities (e.g., from UE1 to UE2) without routing through the scheduling entity (e.g., UE or BS), although the scheduling entity may be used for scheduling and/or control purposes. In some cases, sidelink signals may be communicated using a licensed spectrum, unlike wireless local area networks, which typically use an unlicensed spectrum.

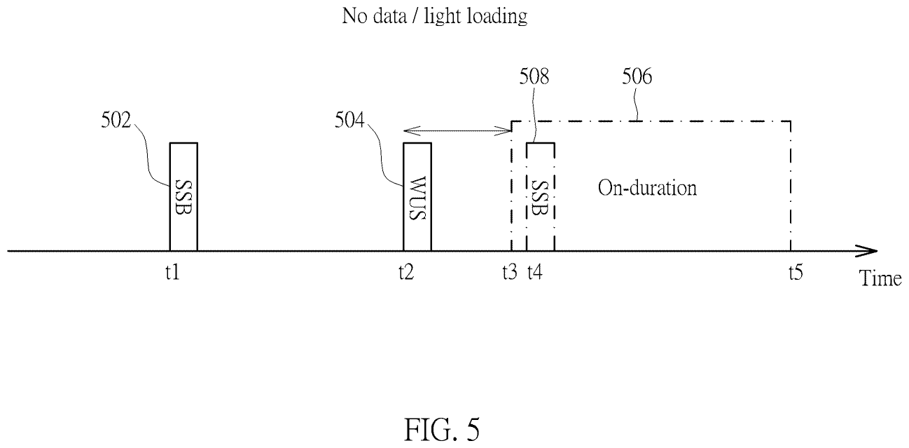

FIG. 5 illustrates the timing sequence for a UE operating in a no data or light loading scenario with WUS enabled. The timeline represents the progression of time with specific time markers showing the sequence of events during a Connected Discontinuous Reception (CDRX) cycle.

At time t1, the UE (e.g., UE 104) receives Synchronization Signal Block (SSB) 502 transmitted by the network (e.g., network 190). The SSB 502 provides timing and frequency synchronization information to the UE, establishing the reference for subsequent communication events.

At time t2, the UE performs Wake-Up Signal (WUS) 504 monitoring, during which the UE monitors Downlink Control Information (DCI) format 2_6 for wake-up indications from the network. The WUS period allows the network to inform the UE whether data transmission is pending for the upcoming CDRX on-duration. The UE monitors DCI format 2_6 during a one-slot WUS monitoring window. The network-configured PS-offset parameter determines the timing gap between this WUS monitoring occasion and the corresponding CDRX on-duration period.

CDRX on-duration period 506 spans from time t3 to t5. The dashed line representation indicates conditional or potential operation rather than actual activity. This period represents the scheduled time window during which the UE would normally monitor the Physical Downlink Control Channel (PDCCH) for potential control information and data reception. During the on-duration period, the UE maintains an active receiver state to decode PDCCH transmissions that may contain downlink control information such as downlink assignments, uplink grants, or other scheduling commands. If the wake-up indication from WUS 504 signals that no data is pending, the UE may choose to remain in sleep mode throughout the entire on-duration period, thereby conserving power that would otherwise be consumed during active PDCCH monitoring. In contrast, if the wake-up indication signals pending data transmission, the UE would actively monitor the PDCCH throughout the on-duration period to receive the intended control information and data.

At time t4, if the UE actively monitors the PDCCH throughout the on-duration period 506, the UE may receive SSB 508 from the network that occurs within the on-duration period. The SSB 508 transmission provides continued synchronization reference during the CDRX on-duration window, thereby maintaining the synchronization between the UE and the network.

The temporal sequence demonstrates that SSB 502 occurs first at t1, followed by WUS 504 at t2, then the on-duration 506 begins at t3, and SSB 508 occurs within the on-duration period at t4. In the no data or light loading scenario depicted, the UE evaluates the wake-up indication received during the WUS monitoring period to determine whether to proceed with active PDCCH monitoring during the on-duration window. This operational sequence represents the WUS-enabled CDRX behavior that the UE maintains when operating under light data activity conditions, where the additional WUS monitoring overhead provides power saving benefits by potentially avoiding unnecessary PDCCH monitoring periods when no data is pending.

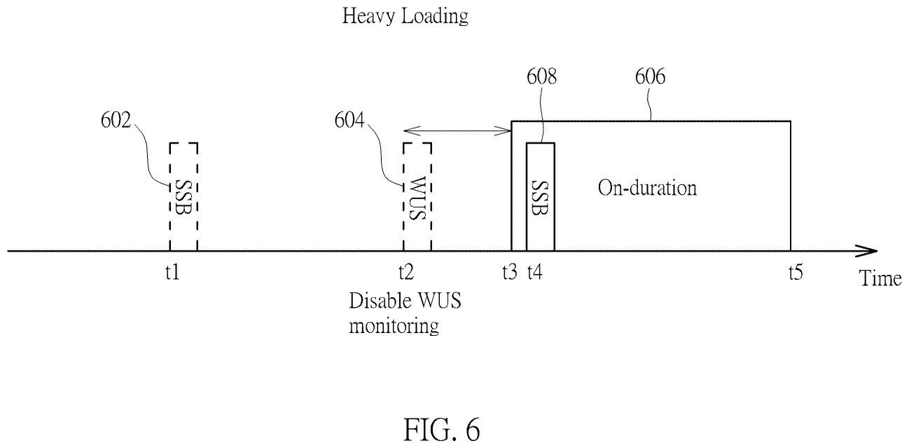

FIG. 6 illustrates the timing sequence for a UE operating in a heavy loading scenario with Wake-Up Signal (WUS) disabled. The horizontal timeline represents the progression of time with specific time markers t1, t2, t3, t4, and t5, showing the modified sequence of events during a CDRX cycle when WUS monitoring has been bypassed.

At time t1, SSB 602, shown as a dashed box, indicating that the UE (e.g., UE 104) may not actively monitor or receive this Synchronization Signal Block transmission prior to WUS monitoring. At time t2, WUS 604, similarly shown in dash, indicates WUS may not be received by the UE and that Wake-Up Signal monitoring is disabled. In other words, both the SSB reception at t1 and WUS monitoring at t2 can be bypassed in this mode. The UE skips both the initial SSB reception and WUS monitoring phases and proceeds directly to the CDRX on-duration monitoring. Note that SSB timing relative to CDRX periods depends on network configuration, and the example shown illustrates a case where the SSB occasion is scheduled within the CDRX on-duration period.

The on-duration period 606 spanning from time t3 to t5 indicates that the CDRX on-duration monitoring behavior, where the UE unconditionally monitors the PDCCH for control information and data reception without any WUS-based conditional logic. This represents the conventional CDRX cycle without WUS, where the UE always actively monitors during the scheduled on-duration periods. At time t4, the UE can receive SSB 608 from the network that occurs within the on-duration period.

The temporal sequence demonstrates the heavy loading scenario operation where SSB 602 at time t1 and the WUS at time t2 are bypassed. The UE can revert to monitoring the CDRX on-duration 606 from t3 to t5, with SSB 608 received at t4 during active monitoring. This operational sequence represents the adaptive WUS management behavior where the UE eliminates the power consumption penalty associated with WUS monitoring in scenarios with continuous or frequent data activity by reverting to the CDRX on-duration monitoring approach. By disabling WUS monitoring and returning to conventional CDRX behavior, the UE can avoid the additional wake-up overhead that WUS introduces, thereby optimizing power consumption for heavy loading scenarios where data transmission is frequent and predictable.

The UE (e.g., UE 104) may employ a statistical analysis approach to determine data loading scenarios by monitoring several previous CDRX cycles to assess data activity patterns. The UE can perform continuous analysis of the presence or absence of data transmissions during these CDRX cycles to evaluate the current data loading level. The historical pattern analysis enables the UE to classify different user scenarios that may result in distinct data loading characteristics. In other words, the UE determines whether to disable WUS monitoring based on a data usage ratio that compares active data periods to total monitoring periods within the predetermined monitoring window.

The loading definition process involves examining data activity across multiple CDRX on-duration periods, where the UE tracks whether data transmissions occurred during each monitored cycle. By accumulating this statistical information over a predetermined monitoring period, the UE can identify patterns that may correspond to different application usage scenarios. Different user scenarios naturally result in different data loading patterns, with applications such as messaging and social media interaction producing sporadic data patterns, while applications like voice calls, real-time gaming, and live video streaming may generate continuous or frequent data patterns.

A light loading scenario can be characterized by sporadic data activity patterns where data transmissions occur infrequently across the monitored CDRX cycles. This scenario typically encompasses applications such as messaging services, music streaming with background operation, and social media interaction where data exchanges may happen in bursts separated by extended idle periods. In light loading scenarios, the data usage of the UE remains below a predetermined threshold within the specified monitoring time period, indicating that the additional overhead of WUS monitoring may be justified by the potential power savings achieved when data transmissions are absent.

The UE may maintain WUS-enabled CDRX operation during light loading scenarios, where the system continues to monitor DCI format 2_6 during wake-up signal monitoring occasions prior to each CDRX on-duration period. This approach allows the network to signal the UE when no data is pending, enabling the UE to skip PDCCH monitoring during the on-duration and may achieve significant power savings.

In contrast, a heavy loading scenario can be characterized by continuous or frequent data activity patterns where data transmissions occur regularly across the monitored CDRX cycles. This scenario includes applications such as Voice over New Radio (VoNR) calls, Voice over Internet Protocol (VoIP) communications, real-time gaming sessions, and live video streaming where data flow is predictable and consistent. In heavy loading scenarios, the data usage of the UE exceeds a predetermined threshold within the specified monitoring time period, which causes the additional overhead of WUS monitoring becomes counterproductive to power conservation.

Heavy loading scenarios include specific detection of VoNR traffic patterns, which are characterized by periodic data transmissions at predetermined intervals that create recognizable patterns indicative of voice communication over the New Radio network. The system can identify these patterns through analysis of data transmission timing and frequency characteristics that may indicate voice communication activity.

The determination to disable WUS monitoring can be based on dynamic threshold calculations that may adapt to the specific CDRX and WUS configuration parameters deployed in the network. The UE can define different threshold values based on the current CDRX configuration, where factors such as CDRX long cycle offset configuration and Power Saving (PS) offset configuration may directly impact the threshold calculation process. Different CDRX long cycle offset values or PS offset values can result in corresponding adjustments to the threshold values used for determining when WUS monitoring should be disabled.

The threshold can be configuration dependent where the threshold for WUS disabling may vary based on network timing parameters. In networks with longer CDRX cycles, the threshold for transitioning to heavy loading classification may be adjusted to account for the different timing characteristics. Similarly, variations in PS offset configurations may require corresponding adjustments to ensure optimal power management performance across diverse network deployments.

In heavy loading scenarios, the UE may have an increased probability of disabling WUS monitoring to achieve greater power savings. The threshold calculation provides that WUS disabling may occur at the optimal point where the power consumed by WUS monitoring exceeds the power that would be saved by conditional PDCCH monitoring.

When the UE determines that the current usage pattern corresponds to a light loading scenario, the UE can maintain CDRX operation with WUS monitoring enabled, allowing the network to provide wake-up indications that can result in power savings when no data is pending. Conversely, when the UE determines that the current usage pattern corresponds to a heavy loading scenario, the UE can switch to monitor the CDRX on-duration without WUS monitoring, eliminating the additional wake-up overhead.

The switching mechanism operates such that UE can transition between WUS-enabled and WUS-disabled modes based on real-time changes in data usage patterns. This adaptive method provide that power consumption may be optimized according to the current application demands, with the UE adaptively selecting the most efficient power management strategy for each identified scenario. The switching decision can be based on the comparison of current data usage patterns against the calculated thresholds, ensuring that transitions may occur at the proper timing for optimal power efficiency across diverse usage scenarios.

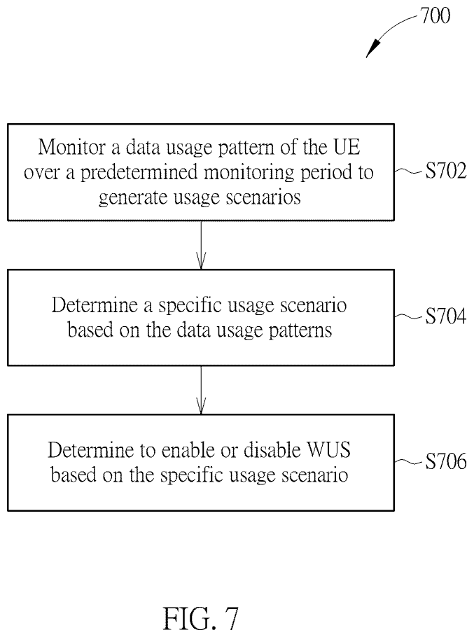

FIG. 7 illustrates a method 700 for WUS management according to an embodiment. The method 700 includes the following steps:
S702: Monitor a data usage pattern of the UE over a predetermined monitoring period to generate a plurality of usage scenarios;
S704: Determine a usage scenario based on the data usage patterns; and
S706: Determine to enable or disable WUS based on the specific usage scenario.

Step S702 involves monitoring a data usage pattern of the UE over a predetermined monitoring period to generate usage scenarios. This monitoring process encompasses data activity tracking, where the UE continuously monitors data transmission and reception events across multiple Connected Discontinuous Reception (CDRX) cycles. The monitoring may include tracking the presence or absence of data transmissions during CDRX on-duration periods, recording the frequency of data exchanges, and analyzing the temporal distribution of communication sessions to build a comprehensive understanding of the UE's communication behavior.

During the predetermined monitoring period, the UE accumulates statistical information about data activity patterns through a systematic pattern collection process. This collection may involve analyzing application-specific traffic characteristics, such as distinguishing between enhanced Mobile Broadband (eMBB) traffic patterns that typically exhibit bursty high-bandwidth characteristics, Ultra-Reliable Low Latency Communication (URLLC) traffic patterns that require consistent low-latency performance, and massive Machine Type Communication (mMTC) traffic patterns that generally involve small, infrequent data transmissions. The UE performs historical pattern analysis by examining data usage trends over the monitoring period, which may include evaluating data usage frequency, identifying periodic patterns that may indicate specific application types such as Voice over New Radio (VoNR), and assessing the consistency of data activity levels across different time periods.

Based on the collected data patterns, the UE can then generate a plurality of usage scenarios that represent different operational contexts. These scenarios may include no data scenarios where data usage is zero within the monitoring period; light loading scenarios where data usage remains below predetermined thresholds and is characterized by sporadic activity; heavy loading scenarios where data usage exceeds predetermined thresholds and exhibits continuous or frequent data activity patterns. This process enables the UE to categorize its operational context for appropriate power management decisions.

Step S704 involves determining a specific usage scenario based on the data usage patterns collected in step S702. This determination process begins with threshold comparison, where the UE compares the monitored data usage patterns against adaptively calculated thresholds. The thresholds may be calculated based on network configuration parameters, including CDRX long cycle offset configuration, Power Saving (PS) offset configuration, and WUS configuration parameters. Different network configurations may result in different threshold values to optimize the decision-making process and ensure that the WUS enable/disable decisions are appropriate for the specific network deployment characteristics.

The UE classifies the current data usage pattern into one of the plurality of usage scenarios through a pattern classification process. The classification may involve analyzing the frequency of data transmission events, evaluating the temporal distribution of data activity, and identifying specific traffic patterns that may indicate particular application types. If the data usage pattern indicates sporadic data activity with infrequent transmissions across monitored CDRX cycles, the UE may classify the scenario as light loading. This classification typically corresponds to applications such as messaging services, social media interaction, or background music streaming where data exchanges occur in bursts separated by extended idle periods.

Conversely, if the data usage pattern indicates continuous or frequent data activity across monitored CDRX cycles, the UE may classify the scenario as heavy loading. The classification may encompass applications such as VoNR calls, real-time gaming, or live video streaming where data flow is predictable and consistent. The UE may specifically detect VoNR traffic patterns characterized by periodic data transmissions at predetermined intervals, involving analysis of data transmission timing and frequency characteristics that may indicate voice communication activity over the New Radio network. This specialized pattern recognition capability enables the UE to identify voice communication scenarios that have distinct power management requirements.

Step S706 involves determining whether to enable or disable WUS based on the usage scenario identified in step S704. When the UE determines that the current usage scenario corresponds to light loading, the method may maintain WUS monitoring in the enabled state. In this configuration, the UE continues to monitor DCI format 2_6 during wake-up signal monitoring occasions prior to each CDRX on-duration period. This technique allows the network to provide wake-up indications that may result in power savings when no data is pending, as the UE can remain in sleep mode throughout the CDRX on-duration period when the wake-up indication signals no pending data transmission.

When the UE determines that the current usage scenario corresponds to heavy loading, the UE may switch to disable WUS monitoring. In this configuration, the UE bypasses the wake-up signal monitoring occasions and reverts to monitoring the CDRX on-duration without WUS intervention. This eliminates the additional wake-up overhead that WUS monitoring introduces and may optimize power consumption for scenarios with frequent data activity, where the UE would typically need to remain awake for most CDRX on-duration periods regardless of wake-up indications.

The method may include provisions for adaptively switching between WUS-enabled and WUS-disabled modes based on real-time changes in data usage patterns. This adaptive capability provides that the UE can respond to evolving application demands and usage patterns without requiring manual intervention. The WUS enable/disable decision may depend on current network configuration parameters. The UE may adjust its decision-making criteria based on factors such as CDRX cycle lengths, power saving offset configurations, and WUS timing parameters to provide optimal performance across diverse network deployments.

The method 700 provides several technical advantages over conventional WUS implementations through its adaptive management strategy. By adaptively adjusting WUS operation based on actual usage patterns, the method may optimize power consumption for diverse application scenarios. The method incorporates intelligent decision-making capabilities that may adapt to different network configurations and usage contexts, enabling more sophisticated power management than simple static approaches. The continuous monitoring and dynamic switching capabilities enable the UE to respond to changing application demands and usage patterns in real-time, ensuring that power management remains optimal as user behavior and application requirements evolve throughout the day.

Furthermore, the method operates within the existing 3GPP framework while providing enhancement for WUS management, maintaining compatibility with current and future network deployments. The compliance to the 3GPP standards means that the method can be implemented without requiring changes to network infrastructure, making it feasible for deployment across diverse network environments.

For clarity in this specification, certain terminological conventions are observed. The singular forms “a”, “an”, and “the” are intended to encompass plural forms as well, unless the context clearly indicates otherwise. The term “and/or” refers to and encompasses any and all possible combinations of one or more of the associated listed items. The terms “includes,” “including,” “comprises,” and “comprising” specify the presence of stated features, integers, steps, operations, elements, and/or components, but do not preclude the presence or addition of one or more other features, integers, steps, operations, elements, components, and/or groups thereof.

The term “exemplary” is used herein to mean “serving as an example, instance, or illustration” and should not be construed as necessarily preferred or advantageous over other aspects or designs.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain image/voice or data/control information, regardless of whether these signals are analog or digital in nature.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from +20% in broader applications to progressively tighter tolerances of +10%, +5%, +3%, +2%, +1%, or +0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

In the context of this patent specification, the term “user equipment” (UE) encompasses a broad range of devices possessing radio communication capabilities. This definition includes, but is not limited to, smartphones (specifically, handheld touchscreen mobile computing devices capable of connecting to one or more cellular networks), Personal Data Assistants (PDAs), pagers, laptop computers, desktop computers, wireless handsets, and any computing device equipped with a wireless communications interface. User equipment may also be referred to by various alternative terms, including but not limited to: client, mobile device, mobile terminal, user terminal, mobile unit, mobile station, mobile user, subscriber, user, remote station, access agent, user agent, receiver, radio equipment, reconfigurable radio equipment, or reconfigurable mobile device. These terms should be considered interchangeable within the context of this document.

The scope of UEs also extends to Internet of Things (IOT) devices. IoT UEs are characterized by a network access layer specifically designed for low-power IoT applications that typically involve short-lived UE connections. These IoT UEs may employ various technologies for data exchange, including Machine-to-Machine (M2M), Machine Type Communication (MTC), or massive MTC (mMTC). Such data exchanges may occur with an MTC server or device via a Public Land Mobile Network (PLMN), with other UEs using Proximity Services (ProSe) or Device-to-Device (D2D) communications, or through sensor networks or IoT networks. It is noteworthy that M2M or MTC data exchanges are often initiated by the machine itself rather than by human intervention.

An IoT network, as referenced in the above section, describes an interconnected system of IoT UEs. These UEs may include uniquely identifiable embedded computing devices integrated within the broader Internet infrastructure. IoT UEs may execute background applications, such as keep-alive messages or status updates, to maintain and facilitate the connections within the IoT network.

UEs are configured to establish communicative coupling with Radio Access Networks (RANs) through a radio interface. This radio interface is a physical communication interface or layer designed to operate with various cellular communication protocols. These protocols may include, but are not limited to, Global System for Mobile Communications (GSM) protocol, Code Division Multiple Access (CDMA) network protocol, Push-to-Talk (PTT) protocol, PTT over Cellular (POC) protocol, Universal Mobile Telecommunications System (UMTS) protocol, 3rd Generation Partnership Project Long-Term Evolution (3GPP LTE) protocol, 5G protocol, and New Radio (NR) protocol.

As a specific example, a UE and a RAN may utilize a Uu interface (such as an LTE-Uu interface) to exchange control plane data. This exchange occurs via a protocol stack comprising multiple layers: a Physical (PHY) layer, a Medium Access Control (MAC) layer, a Radio Link Control (RLC) layer, a Packet Data Convergence Protocol (PDCP) layer, and a Radio Resource Control (RRC) layer. In this context, a Downlink (DL) transmission refers to data sent from the RAN to the UE, while an Uplink (UL) transmission refers to data sent from the UE to the RAN.

Furthermore, UEs may employ a sidelink for direct communication with other UEs, facilitating D2D, Peer-to-Peer (P2P), and/or ProSe communication. A ProSe interface, for instance, may incorporate one or more logical channels. These channels include, but are not limited to, a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The various aspects described herein may be implemented using a variety of hardware and software components. These may include processors, Digital Signal Processors (DSPs), Application Specific Integrated Circuits (ASICs), Field Programmable Gate Arrays (FPGAs) or other programmable logic devices, discrete gates or transistor logic, or discrete hardware components. A processor in this context may be a microprocessor, but could also be any conventional processor, controller, microcontroller, or state machine. Processors may also be implemented as combinations of computing devices, such as a combination of a DSP and a microprocessor, multiple microprocessors, one or more microprocessors in conjunction with a DSP core, or any other such configuration.

The aspects described in this specification can be implemented through both hardware and software instructions. These instructions may be stored on various types of computer-readable media, including but not limited to Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical configuration, the storage medium is connected to a processor, enabling the processor to read information from and write information to the medium. In some configurations, the storage medium may be integral to the processor itself.

In some embodiments, the computing instructions may be executed by an operating system, which may include but is not limited to Microsoft Windows, Apple Mac OS X, macOS or iOS, various distributions of the Linux operating system, or Google Android operating system.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

In implementations where the systems described in this specification collect user information, provisions may be made to protect user privacy and data. Specifically, users may be afforded the opportunity to opt in or out of programs or features that collect personal information, such as data related to user preferences or smart device usage patterns. Furthermore, in certain embodiments, data protection measures may be implemented to anonymize collected information prior to storage or utilization. For instance, a user's identity may be anonymized to prevent the determination or association of personally identifiable information with that specific user. Additionally, user preferences and interaction data may be generalized, potentially based on broader demographic categories, rather than being linked to individual users.

It should be noted that the operational steps described in any exemplary aspects within this specification are provided as examples and for discussion purposes. These operations may be performed in numerous different sequences other than the illustrated sequences. Furthermore, operations described in a single step may actually be performed as multiple distinct steps, and multiple steps may be combined into a single operational step. The steps in the appended figures may be subject to numerous modifications as will be apparent to those skilled in the art.

Some embodiments may incorporate all explicitly disclosed features as well as additional features that, while not specifically described herein, are compatible with and enhance the core invention. Conversely, other embodiments may selectively omit certain non-disclosed elements, either partially or in their entirety, while still falling within the scope of the invention. This flexibility in feature inclusion or exclusion allows for a range of implementations tailored to specific applications or requirements, without departing from the fundamental principles of the invention.

The logical stages illustrated in the drawings may be reordered, combined, or broken out if they are not order-dependent. The ordering and groupings presented in this specification are not exhaustive, and other arrangements will be apparent to those skilled in the art. These stages may be implemented in hardware, firmware, software, or any combination thereof.

The drawings and descriptions provided in this specification offer detailed illustrations of various embodiments of the invention. However, it should be understood by those skilled in the art that these embodiments can be implemented without necessarily adhering to every specific detail provided herein. In some instances, well-established methods, procedures, components, and circuits have been mentioned without elaborate explanations to avoid obscuring the key aspects of the embodiments. It is important to note that the figures presented in this specification, including any component diagrams, are intended for illustrative purposes and may not be drawn to scale. This allows for a clear presentation of the inventive concepts while leaving room for variations and adaptations within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for power management, performed by a user equipment (UE) operating in a wireless communication network, the method comprising:
monitoring a data usage pattern of the UE over a predetermined monitoring period to generate a plurality of usage scenarios;
determining a usage scenario from the plurality of usage scenarios based on the data usage patterns; and
determining to enable or disable wake-up signaling (WUS) based on the usage scenario.

2. The method of claim 1, further comprising disabling the WUS based on a change of the usage scenario if the WUS is enabled.

3. The method of claim 1, further comprising enabling the WUS based on a change of the usage scenario if the WUS is disabled.

4. The method of claim 1, wherein determining the usage scenario comprises comparing the data usage pattern against at least one threshold calculated based on network configuration parameters.

5. The method of claim 4, wherein the at least one threshold is generated based on at least one of:
CDRX long cycle offset configuration parameters;
Power Saving (PS) offset configuration parameters; or
WUS configuration parameters.

6. The method of claim 1, wherein monitoring the data usage pattern comprises monitoring data activity during a plurality of Connected Discontinuous Reception (CDRX) cycles.

7. The method of claim 6, wherein determining the usage scenario comprises analyzing presence or absence of data transmissions during CDRX on-duration periods across the plurality of CDRX cycles.

8. The method of claim 1, wherein determining to enable WUS comprises configuring the UE to monitor Downlink Control Information (DCI) format 2_6.

9. The method of claim 8, wherein determining to disable the WUS comprises configuring the UE to bypass monitoring the DCI format 2_6 and to monitor Physical Downlink Control Channel (PDCCH) during CDRX on-duration.

10. The method of claim 1, wherein monitoring the data usage pattern comprises monitoring at least one of:
enhanced Mobile Broadband (eMBB) traffic;
Ultra-Reliable Low Latency Communication (URLLC) traffic; or
massive Machine Type Communication (mMTC) traffic.

11. A user equipment (UE) comprising:
a memory; and
a processor coupled to the memory, configured to:
monitor a data usage pattern of the UE over a predetermined monitoring period to generate a plurality of usage scenarios;
determine a usage scenario from the plurality of usage scenarios based on the data usage pattern; and
determine to enable or disable wake-up signaling (WUS) based on the usage scenario.

12. The UE of claim 11, wherein the processor is further configured to disable the WUS based on a change of the usage scenario if the WUS is enabled.

13. The UE of claim 11, wherein the processor is further configured to enable the WUS based on a change of the usage scenario if the WUS is disabled.

14. The UE of claim 11, wherein the processor is further configured to determine the usage scenario by comparing the data usage pattern against at least one threshold calculated based on network configuration parameters.

15. The UE of claim 14, wherein the at least one threshold is generated based on at least one of:
CDRX long cycle offset configuration parameters;
Power Saving (PS) offset configuration parameters; or
WUS configuration parameters.

16. The UE of claim 11, wherein the processor is further configured to monitor the data usage pattern by monitoring data activity during a plurality of Connected Discontinuous Reception (CDRX) cycles.

17. The UE of claim 16, wherein the processor is further configured to analyze presence or absence of data transmissions during CDRX on-duration periods across the plurality of CDRX cycles.

18. The UE of claim 11, wherein the processor is further configured to determine to enable WUS by monitoring Downlink Control Information (DCI) format 2_6.

19. The UE of claim 18, wherein the processor is further configured to determine to disable WUS by bypassing monitoring the DCI format 2_6 and monitoring Physical Downlink Control Channel (PDCCH) during CDRX on-duration.

20. The UE of claim 11, wherein the processor is further configured to monitor at least one of:
enhanced Mobile Broadband (eMBB) traffic;
Ultra-Reliable Low Latency Communication (URLLC) traffic; or
massive Machine Type Communication (mMTC) traffic.
